(19) United States
(12) Patent Application Publication
(10) Pub. No.: US 2017/0058940 A1
(43) Pub. Date: Mar. 2, 2017

(54) RADIAL PILOT FOR SLIP-IN-TUBE DRIVESHAFT

(71) Applicant: Neapco Drivelines, LLC, Belleville, MI (US)

(72) Inventors: Robert J. Wehner, Livonia, MI (US); Stephan H. Schramme, Westland, MI (US)

(21) Appl. No.: 15/246,579

(22) Filed: Aug. 25, 2016

Related U.S. Application Data
(60) Provisional application No. 62/209,954, filed on Aug. 26, 2015.

(51) Int. Cl. F16C 3/03; B21D 17/04; B21D 51/12; F16D 3/04

(52) U.S. Cl. CPC F16C 3/03; F16D 3/04; B21D 17/04; B21D 51/12

(57) ABSTRACT

A driveshaft assembly includes an inner tube. The inner tube has splines formed from a plurality of teeth alternating with a plurality of recesses formed on the inner tube. An outer tube has splines formed from a plurality of teeth alternating with a plurality of recesses formed thereon. The outer tube coaxially receiving the inner tube. The splines of the inner tube engaging the splines of the outer tube. A plurality of protrusions is formed on one of an inner surface of the splines of the outer tube and an outer surface of fewer than an entirety of the plurality of recesses of the splines of the inner tube.

### CROSS-REFERENCE TO RELATED PATENT APPLICATIONS

This patent application claims the benefit of U.S. Provisional Patent Application No. 62/209,954, filed on Aug. 26, 2015. The entire disclosure of the above patent application is hereby incorporated herein by reference.

### FIELD

The present invention relates to a driveshaft tube for a motor vehicle and more particularly to an interface geometry for a driveshaft tube with formed splines.

### BACKGROUND OF THE INVENTION

As commonly known, driveshafts are operatively employed to transfer torque between components of a motor vehicle such as between a transmission assembly and a differential assembly, for example. Certain driveshafts are configured as slip-in-tube driveshafts. Slip-in-tube driveshafts include an inner tube having splines formed in a wall thereof and an outer tube having splines formed in a wall thereof. The inner tube is coaxially received in the outer tube. The splines of the inner tube cooperate with the splines of the outer tube to transmit the torque between the inner tube and the outer tube, while providing low plunge force, or low resistance to telescoping movement between the inner and outer tube as required for ease of vehicle assembly and smooth operation in a vehicle.

The splines may be formed by a spline forming process commonly known for manufacturing slip-in-tube driveshafts such as a GROB spline forming metal displacement process, for example. To form the splines, the tubes are positioned about an internal mandrel with splines. Two or three rollers located 180 degrees or 120 degrees apart from each other and rotating around individual axes cooperate with the internal mandrel to form the splines on the tubes. The inner tube is joined to the outer tube with as little radial interference as possible to avoid changes in driveline imbalance that may occur as a result of radial clearances between the inner and outer tubes. In the quest to minimize radial clearance, a very small interference fit may be present in some cases, resulting in unacceptably high telescoping plunge loads between the inner tube and the outer tube.

It is desirable to produce an improved design for slip-in-tube driveshafts that allows the outer tube to coaxially receive the inner tube with minimal radial clearance, or minimal radial interference, without providing undesirably high resistance to axial movement. Some known driveshafts include features to minimize a radial clearance between the inner tube and the outer tube. For example, the inner tube of the driveshaft may include raised protrusions formed thereon. However, in these driveshafts, an interference fit between the inner tube and the outer tube cannot be achieved without an undesirable axial plunge force. The shortcoming of such protrusions is they are currently formed on the outside surface of the inner tube spline roots by impact rollers of the spline forming metal displacement process, which requires the protrusions to be formed on every recess of the splines of the inner tube. When a small interference fit is present, the small interference fit results in an elevated resistance of the outer tube and the inner tube to diametral expansion and contraction, which can cause the undesirable high axial plunge force. Furthermore, these features can increase a complexity of manufacturing and assembly.

Accordingly, it would be desirable to provide a driveshaft assembly with an interface geometry feature that minimizes an axial plunge force, a radial clearance, and a resistance to axial movement when creating an interference fit between the inner tube and the outer tube thereof. Additionally, it would be desired to provide a driveshaft that minimizes a complexity of manufacturing and assembly.

### SUMMARY OF THE INVENTION

In accordance and attuned with the present invention, a driveshaft assembly with an interface geometry feature that minimizes an axial plunge force, a radial clearance, and a resistance to axial movement when creating an interference fitting between an inner tube and an outer tube thereof while minimizing a complexity of manufacturing and assembly, has surprisingly been discovered.

According to an embodiment of the disclosure, a driveshaft assembly is disclosed.

The assembly includes an inner tube having splines formed from a plurality of teeth alternating with a plurality of recesses. An outer tube has splines formed from a plurality of teeth alternating with a plurality of recesses. The outer tube coaxially receives the inner tube. The splines of the inner tube engage the splines of the outer tube. A plurality of protrusions is formed on one of an inner surface of the splines of the outer tube and an outer surface of fewer than an entirety of the recesses of the splines of the inner tube.

According to another embodiment of the disclosure, a driveshaft assembly is disclosed. The assembly includes an inner tube having splines formed thereon. The splines of the inner tube are formed from a plurality of teeth interposed between a plurality of recesses. An outer tube has splines formed thereon and coaxially receives the inner tube. The splines of the outer tube are formed from a plurality of teeth interposed between a plurality of recesses. The splines of the inner tube engage the splines of the outer tube. A plurality of protrusions are formed on an inner surface of at least a portion of the plurality of recesses of the splines of the outer tube.

According to yet another embodiment of the disclosure, a method of forming an outer tube of a driveshaft assembly including an inner tube and the outer rube is disclosed. The method includes the steps of providing a spline forming metal displacement process apparatus. The apparatus includes an inner mandrel and a plurality of impact rollers configured to move into and out of engagement with the inner mandrel. The inner mandrel has a plurality of recesses formed thereon. The method includes the step of forming a plurality of indentations in at least a portion of the plurality of recesses of the inner mandrel and positioning the outer tube of the driveshaft assembly on the inner mandrel over the plurality of recesses formed on the inner mandrel. The method further includes the step of engaging the impact rollers with portions of the outer tube aligning with the plurality of recesses of the inner mandrel to displace the portions of the outer tube inwardly towards the plurality of recesses and the plurality of indentations of the inner mandrel to form splines on the outer tube and a plurality of protrusions extending from an inner surface of the splines of the outer tube. A quantity of the plurality of protrusions corresponds to a number of the plurality of indentations.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The above advantages of the invention will become readily apparent to those skilled in the art from reading the following detailed description of an embodiment of the invention in the light of the accompanying drawings, in which:

FIG. 1 is a front perspective view of a driveshaft assembly according to an embodiment of the present disclosure;

FIG. 2 is a cross-sectional view of the driveshaft assembly of FIG. 1, taken along the line 2-2;

FIG. 3 is a schematic cross-sectional view of a spline forming metal displacement process apparatus for forming portions of the driveshaft assembly of FIGS. 1-2, wherein the spline forming metal displacement process apparatus includes three impact rollers;

FIG. 4 is a schematic perspective view of a spline forming metal displacement process apparatus for forming portions of the driveshaft assembly of FIGS. 1-2, wherein the spline forming metal displacement process apparatus includes two impact rollers;

FIG. 5 is a cross-sectional view of the driveshaft assembly of FIG. 1, taken along the line 2-2, according to another embodiment of the disclosure.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

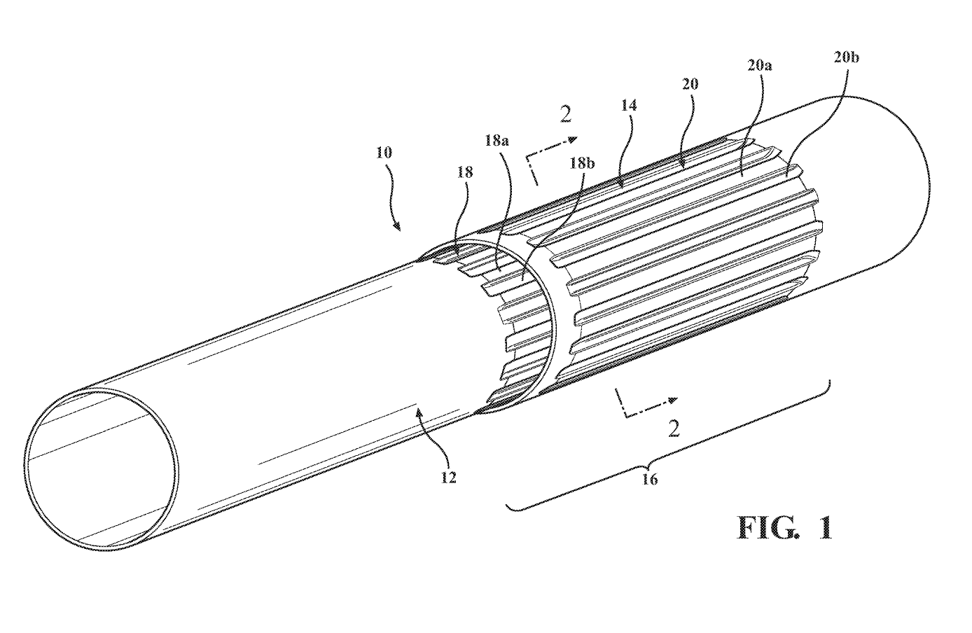

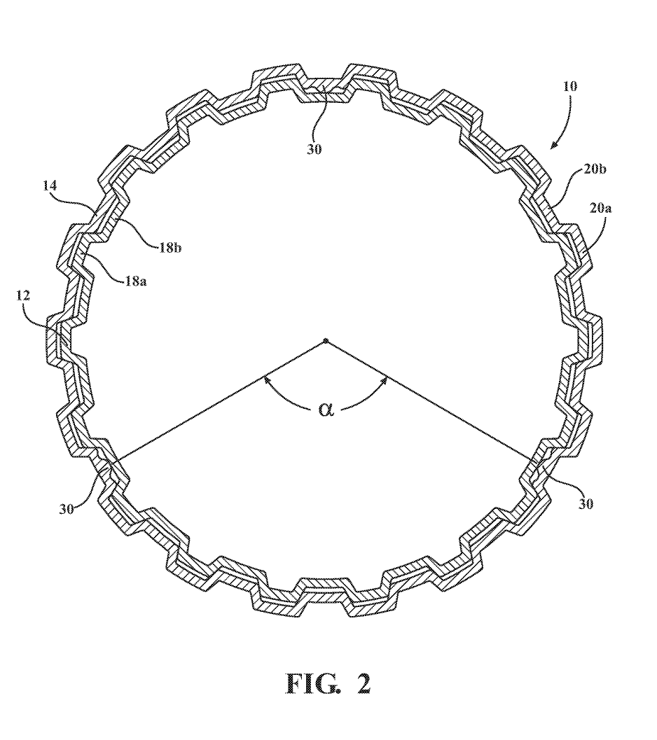

FIGS. 1-2 illustrate a driveshaft assembly 10. The driveshaft assembly 10 is configured as a slip-in-tube driveshaft for use in a motor vehicle. The driveshaft assembly 10 includes an inner tube 12 and an outer tube 14. The inner tube 12 and the outer tube 14 are joined together by an interference fit at an interface portion 16 thereof.

The inner tube 12 includes splines 18 formed in a portion of a wall forming the inner tube 12. The splines 18 of the inner tube 12 include equally spaced and alternating teeth 18a and recesses 18b axially formed in the wall of the inner tube 12. In the embodiment illustrated, eighteen teeth 18a are formed in the wall of the inner tube 12. However, it is understood that more than eighteen or fewer than eighteen teeth 18a can be formed in the wall of the inner tube 12. The splines 18 shown and described herein are formed from a spline forming metal displacement process such as a GROB spline forming metal displacement process, for example. However, it is understood the splines 18 can be formed from other processes now known or later developed.

The outer tube 14 includes splines 20 formed in a portion of a wall forming the outer tube 14. The splines 20 of the outer tube 14 include equally spaced and alternating teeth 20a and recesses 20b axially formed in the wall of the outer tube 14. In the embodiment illustrated, eighteen teeth 20a are formed in the wall of the outer tube 14. However, it is understood that more than eighteen or fewer than eighteen teeth 20a can be formed in the wall of the outer tube 14. The splines 20 shown and described herein are formed from the spline forming metal displacement process. However, it is understood the splines 20 can be formed from other processes now known or later developed.

The inner tube 12 is coaxially received in the outer tube 14, wherein the teeth 18a of the inner tube 12 engage with a radial inner surface of the teeth 20a of the outer tube 14 and the recesses 20b of the outer tube 14 engage with the radial outer surface of the recesses 18b of the inner tube 12 at the interface portion 16 of the driveshaft assembly 10. The splines 18 of the inner tube 12 cooperate with the splines 20 of the outer tube 14 to facilitate transmitting torque between the tubes 12, 14.

As shown in FIG. 2, the outer tube 14 includes protrusions 30 formed on and extending outwardly from a radial inner surface of the splines 20. The protrusions 30 are spaced equidistant from each other. In the embodiment illustrated, three protrusions 30 spaced at an angle a from each other are formed on the radial inner surface of the splines 20 of the outer tube 14. The angle a in the embodiment shown is about 120 degrees. However, the angle a can be any other angle as desired such as about 180 degrees, about 30 degrees, or about 20 degrees, for example, depending on the desired location or the number of splines 20 formed on the outer tube 14. Each of the three protrusions 30 is formed on one of three recesses 20b of the splines 20 equally spaced from each other. However, in another embodiment, the protrusions 30 are formed on each one of the recesses 20b of the outer tube 14 or alternating ones of the recesses 20b of the outer tube 14. It is understood other configurations of the protrusions 30 formed on the splines 20 of the outer tube 14 can be contemplated to achieve desired results.

The protrusions 30 have a substantially arcuate cross-sectional shape and are positioned in a substantially central portion of the inner radial surface of the recesses 20b of the outer tube 14. However, other cross-sectional shapes and positions offset from the substantially central portion of the inner radial surface of the recesses 20b can be contemplated as desired. In a non-limiting example, each of the protrusions 30 can extend the entire length of the splines 20. However, in another non-limiting example the protrusions 30 can extend along a portion of the length of the splines 20.

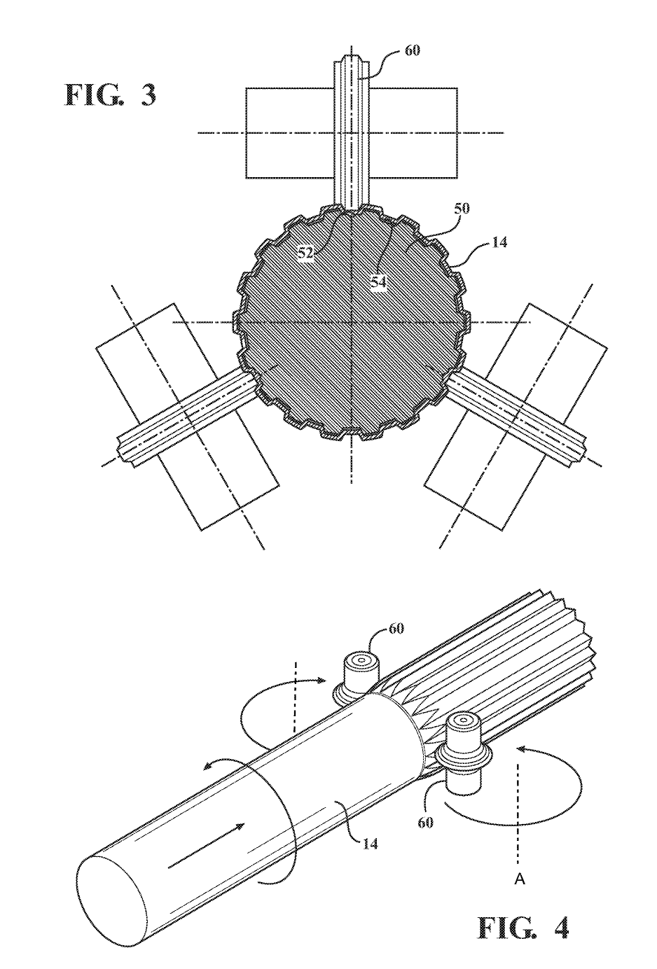

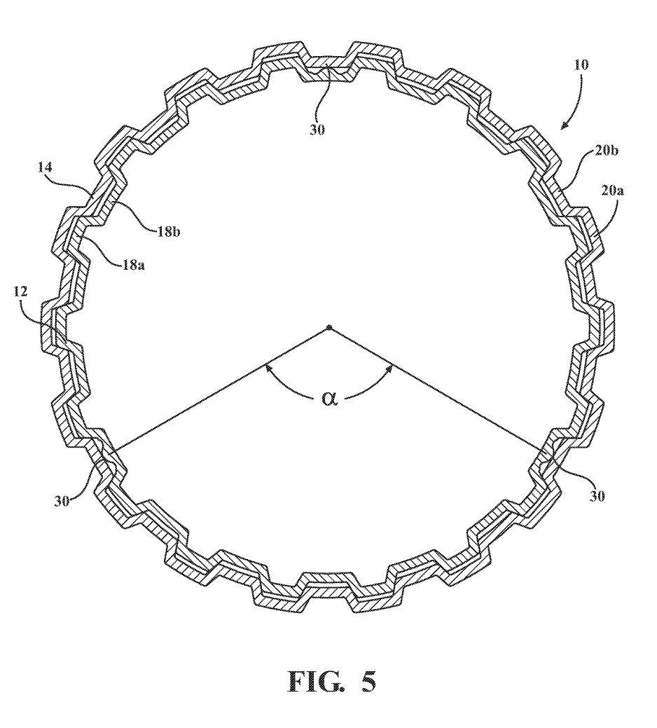

In an exemplary embodiment, as schematically shown in FIGS. 3-4, to form the protrusions 30 of the outer tube 14, indentations 52 are formed on recesses 54 of an inner mandrel 50 used during the spline forming metal displacement process. The spline forming metal displacement process is similar to the GROB spline forming processes utilizing metal displacement shown and described in U.S. Pat. No. 2,715,846 and U.S. Pat. No. 5,471,858, the disclosures of which are hereby incorporated in their entirety herein.

As shown in FIGS. 3-4, an exemplary spline forming metal displacement process apparatus is illustrated. The process includes an apparatus having an inner mandrel 50 and a plurality of impact rollers 60. The inner mandrel 50 includes a plurality of recesses 54 formed in a surface thereof. The inner mandrel 50 moves along an axial direction and rotates about the center axis. The impact rollers 60 are configured to rotate about an axis A and move into and out of engagement with the inner mandrel 50 at a position substantially perpendicular with the surface of the mandrel 50. In an exemplary embodiment, the apparatus includes three impact rollers 60, as shown in FIG. 3, equally radially spaced apart. In another exemplary embodiment, as shown in FIG. 4, the apparatus includes two impact rollers 60 spaced at about 180 degrees from each other. However, more than three or fewer than two impact rollers 60 can be included with the apparatus as desired.

In application, the outer tube 14 is positioned on the inner mandrel 50 of the spline forming metal displacement process apparatus. The inner mandrel 50 includes the plurality of recesses 54 and the indentations 52. As the inner mandrel 50 and outer tube 14 move along the axial direction and rotate about their rotational axes, the impact rollers 60 rotate and move in and out of engagement with the outer tube 14, repeatedly impacting against a circumferential surface of the outer tube 14, forcing portions of the outer tube 14 inwardly towards the recesses 54 of the inner mandrel 50. During engagement of the impact rollers 60, the splines 20 are formed on the outer tube 14. Specifically, the portions of the outer tube 14 are displaced inwardly towards the recesses 54 of the inner mandrel 50 to form the recesses 20b of the splines 20 of the outer tube 14. The indentations 52 in the recesses 54 of the inner mandrel 50 cause the protrusions 30 to be formed on the outer tube 14 while the splines 20 are being formed. The splines 18 of the inner tube 12 can be formed by a similar process with an inner mandrel that does not include indentations formed thereon. To form the driveshaft assembly 10, the inner tube 12 is then received by and engages with the outer tube 14 by an interference fit, wherein the splines 18 of the inner tube 12 correspond and engagingly align with the splines 20 of the outer tube 14. After assembly, the protrusions 30 abut the recesses 18b of the inner tube 12.

Advantageously, due to the protrusions 30, the inference fit between the inner tube 12 and the outer tube 14 can be achieved with minimal complexity of manufacturing and assembly. The indentations 52 can be easily formed on inner mandrels 50 used during the spline forming metal displacement process. The protrusions 30 facilitate minimizing a resistance of the inner tube 12 and the outer tube 14 to out-of-round deformation which, in turn, minimizes the axial plunge force, the radial clearance, and the resistance to axial movement of the driveshaft assembly 10 in use.

Additionally, in an alternate embodiment, protrusions 30 can be formed on the outer radial surface of the recesses 18b of the inner tube 12. One protrusion 30 can be formed on fewer than an entirety of the recesses 18b of the inner tube 12. The protrusions 30 formed on fewer than an entirety of the recesses 18b of the inner tube 12 results in a minimization of an elevated resistance of the outer tube 14 and the inner tube 12 to diametral expansion and contraction, which minimizes an axial plunge force used to assemble the driveshaft assembly 10. For example, where eighteen recesses 18b are formed on the inner tube 12, fewer than eighteen of the recesses 18b include one of the protrusions 30. In further non-limiting examples, protrusions 30 can be formed on alternating recesses 18b or every two or three recesses 18b. The inner tube 12 can include one, two, three, or four recesses 18b with the protrusions 30 formed thereon. The number of recesses 18b including protrusions 30 formed is typically fewer than the total number of recesses 18b. In one exemplary embodiment, to form the protrusions 30, the inner mandrel 50 used to form the splines 18 of the inner tube 12 during the spline forming process includes indentations formed in the recesses 54 thereon corresponding to the number of desired protrusions 30. In another exemplary embodiment, to form the protrusions 30, a recess is formed in the impact rollers 60. As the impact rollers 60 impact the outer tube 14, the protrusions 30 are formed on the recesses 18b of the inner tube 12. According to this embodiment, where the number of recesses 18b including protrusions 30 is less than the total number of recesses 18b, radial contact interference allows the inner tube 12 and the outer tube 14 to deform with less resistance by creating a slight out-of-round condition.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A driveshaft assembly comprising:
an inner tube having splines formed from a plurality of teeth alternating with a plurality of recesses;
an outer tube having splines formed from a plurality of teeth alternating with a plurality of recesses, the outer tube coaxially receiving the inner tube, the splines of the inner tube engaging the splines of the outer tube; and
a plurality of protrusions formed on one of an inner surface of the splines of the outer tube and an outer surface of fewer than an entirety of the recesses of the splines of the inner tube.

2. The driveshaft assembly of claim 1, wherein the plurality of protrusions is formed on the inner surface of the splines of the outer tube.

3. The driveshaft assembly of claim 2, wherein the plurality of teeth and the plurality of recesses of the splines of the outer tube are equally spaced.

4. The driveshaft assembly of claim 3, wherein the plurality of protrusions is formed on the inner surface of at least a portion of the recesses of the splines of the outer tube.

5. The driveshaft assembly of claim 2, wherein the plurality of protrusions extends a length of the splines of the outer tube.

6. The driveshaft assembly claim 1, wherein the plurality of protrusions is spaced at about 120 degrees from each other.

7. The driveshaft assembly of claim 1, wherein each of the plurality of protrusions has an arcuate surface.

8. The driveshaft assembly of claim 1, wherein the plurality of protrusions is formed on the outer surface of fewer than the entirety of the plurality of recesses of the splines of the inner tube.

9. The driveshaft assembly of claim 8, wherein the plurality of teeth and the plurality of recesses of the inner tube are equally spaced.

10. The driveshaft assembly of claim 9, wherein the plurality of protrusions is formed on the outer surface of three of the recesses of the splines of the inner tube.

11. The driveshaft assembly of claim 9, wherein the plurality of protrusions is formed on alternating ones of the outer surface of the recesses of the splines of the inner tube.

12. The driveshaft assembly of claim 8, wherein the plurality of protrusions extends along a length of the splines of the inner tube.

13. The driveshaft assembly of claim 1, wherein the inner tube is coaxially received in and coupled to the outer tube by an interference fit.

14. The driveshaft assembly of claim 1, wherein a quantity of the plurality of teeth formed on each of the inner tube and the outer tube is eighteen.

15. A driveshaft assembly comprising:
an inner tube having splines formed thereon, the splines of the inner tube formed from a plurality of teeth interposed between a plurality of recesses;
an outer tube having splines formed thereon and coaxially receiving the inner tube, the splines of the outer tube formed from a plurality of teeth interposed between a plurality of recesses, the splines of the inner tube engaging the splines of the outer tube; and
a plurality of protrusions formed on an inner surface of at least a portion of the plurality of recesses of the splines of the outer tube.

16. The driveshaft assembly of claim 15, wherein each of the plurality of protrusions has an arcuate surface.

17. The driveshaft assembly of claim 15, wherein each of the plurality of protrusions extends a length of the splines of the outer tube.

18. The driveshaft assembly of claim 15, wherein three protrusions are formed on the inner surface of the plurality of recesses of the splines of the outer tube, and wherein the three protrusions are spaced at about 120 degrees from each other.

19. A method of forming an outer tube of a driveshaft assembly including an inner tube and the outer rube, the method comprising:
providing a spline forming metal displacement process apparatus, the apparatus including an inner mandrel and a plurality of impact rollers configured to move into and out of engagement with the inner mandrel, the inner mandrel having a plurality of recesses formed thereon;
forming a plurality of indentations in at least a portion of the plurality of recesses of the inner mandrel;
positioning the outer tube of the driveshaft assembly on the inner mandrel over the plurality of recesses formed on the inner mandrel;
engaging the impact rollers with portions of the outer tube aligning with the plurality of recesses of the inner mandrel to displace the portions of the outer tube inwardly towards the plurality of recesses and the plurality of indentations of the inner mandrel to form splines on the outer tube and a plurality of protrusions extending from an inner surface of the splines of the outer tube, a quantity of the plurality of protrusions corresponding to a number of the plurality of indentations.

20. The method of claim 19, wherein the quantity of the plurality of protrusions and the plurality of indentations is three.
